(19) United States
(12) Patent Application Publication
(10) Pub. No.: US 2005/0102436 A1
(43) Pub. Date: May 12, 2005

(54) Communication interface circuit

(76) Inventor: Shigenori Kujime, Gunma (JP)

Correspondence Address: FISH & RICHARDSON P.C., 1425 K STREET, N.W., 11TH FLOOR, WASHINGTON, DC, 20005-3500, US

(21) Appl. No.: 10/952,369

(22) Filed: Sep. 29, 2004

(30) Foreign Application Priority Data
Sep. 29, 2003 (JP) 2003-338036

(51) Int. Cl. G06F 3/00

(52) U.S. Cl. 710/1

(57) ABSTRACT

A communication interface circuit which performs control to sequentially transfer transfer-data each having a predetermined size from a first apparatus to a second apparatus. The communication interface circuit comprises a control section that, while sequentially transferring the transfer-data each having the predetermined size to the second apparatus, can suspend the sequential transfer, and where the suspension is effected and then released, resumes the sequential transfer from data subsequent to last transferred data before the suspension out of the transfer-data.

### CROSS-REFERENCE TO RELATED APPLICATIONS

The present application claims priority upon Japanese Patent Application No. 2003-338036 filed on Sep. 29, 2003, which is herein incorporated by reference.

### BACKGROUND OF THE INVENTION

1. Field of the Invention

The present invention relates to a communication interface circuit.

2. Description of the Related Art

In apparatuses such as a microcomputer, a communication interface circuit is used which controls communication with a receive side apparatus as a transfer destination for transfer-data. Such communication interface circuits are a serial interface circuit for converting data such as one byte into serial data and serially transferring, and a parallel interface circuit for transferring plural bits of parallel data. See, for example, Japanese Patent Laid-open Publication No. Hei. 10-283088.

A scheme is required of communication interface circuits wherein transfer is suspended while transferring sequentially transfer-data, for example, at the time when the amount of transfer-data stored in the receive data buffer for temporarily storing transfer-data, provided in the receive side apparatus reaches a predetermined amount.

Moreover, a scheme is required of communication interface circuits wherein after sequentially transferring transfer-data is suspended, when the receive side apparatus becomes ready to receive by moving data from the receive data buffer to RAM or the like, sequential transfer is resumed from data subsequent to data last transferred before the suspension so as not to duplicate transfer of same data.

In conventional communication interface circuits, the above schemes are difficult to implement because of the increase of time required for transfer. After suspension, previously transferred data is re-transferred to the receive side apparatus, and thus malfunction may be caused.

### SUMMARY OF THE INVENTION

The present invention was made in view of the above circumstance. An object of the present invention is to provide a communication interface circuit improved in reliability.

One aspect of the present invention to solve the above problem is a communication interface circuit which performs control to sequentially transfer transfer-data each having a predetermined size from a first apparatus to a second apparatus, the communication interface circuit comprising a control section that, while sequentially transferring the transfer-data each having the predetermined size to the second apparatus, can suspend the sequential transfer, and where the suspension is effected and then released, resumes the sequential transfer from data subsequent to last transferred data before the suspension out of the transfer-data.

As described above, the communication interface circuit can suspend sequential transfer from the first apparatus to the second apparatus as needed, and when the suspension is released, resumes the sequential transfer from data subsequent to last transferred data before the suspension. Thus, duplicate transfer data is not transferred from the first apparatus to the second apparatus, and hence malfunction can be avoided. Furthermore, the traffic amount between the first apparatus and the second apparatus can be reduced by that of duplicate transfer data that would otherwise be transferred, and efficient transfer is possible.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a block diagram showing the configuration of a communication system according to an embodiment of the present invention;

FIG. 2 is a flow chart explaining the operation of a communication interface circuit according to the embodiment of the present invention;

FIG. 3 is a flow chart explaining the operation of the communication interface circuit according to the embodiment of the present invention; and

FIG. 4 is a timing chart explaining the operation of the communication interface circuit according to the embodiment of the present invention.

### DETAILED DESCRIPTION OF THE INVENTION

At least the following matters will be made clear by the explanation in the present specification and the description of the accompanying drawings.

### CONFIGURATION OF A COMMUNICATION SYSTEM

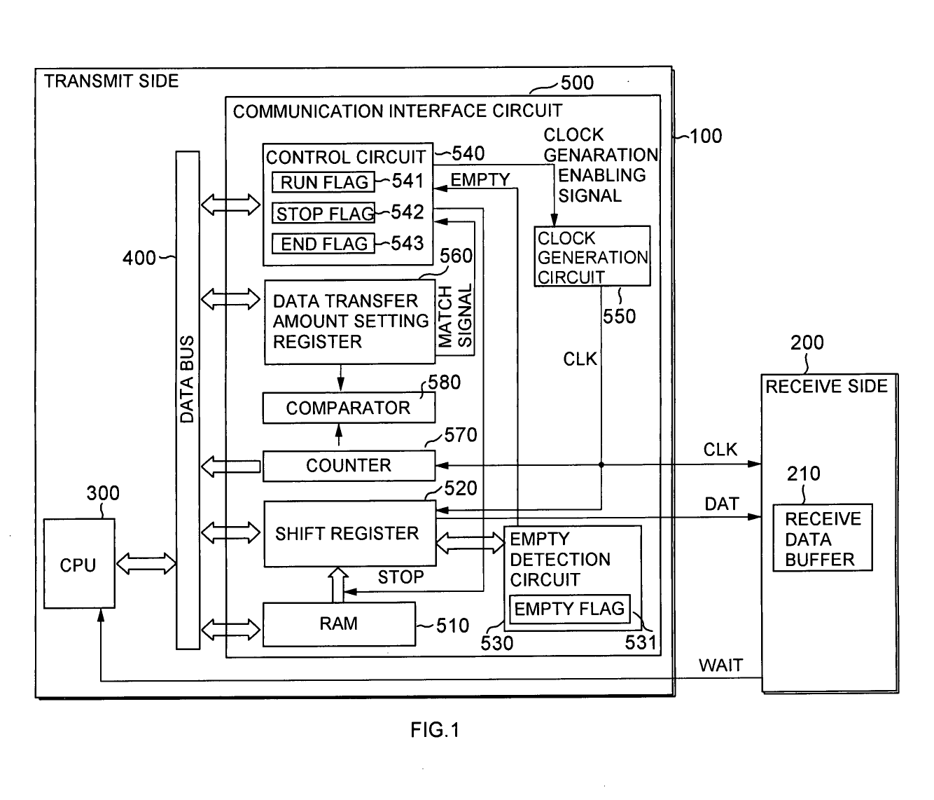

FIG. 1 is a block diagram showing the configuration of a communication system according to the present invention.

In the communication system of the present invention, a transmit side apparatus (first apparatus) 100 and a receive side apparatus (second apparatus) 200 are connected via a data bus and a command bus such that they can communicate with each other.

The transmit side apparatus 100 is an integrated circuit such as a microcomputer, and in the transmit side apparatus 100, a CPU 300 controlling the entire apparatus and a communication interface circuit 500 are connected via an internal data bus 400. The transmit side apparatus 100 transfers transfer-data DAT of a predetermined size (one or a plurality of bytes) and a clock signal CLK used as a system clock of the receive side apparatus 200 such that they are synchronous with each other, to the receive side apparatus 200 via the communication interface circuit 500.

The communication interface circuit 500 is a circuit for controlling data communication between the transmit side apparatus 100 and the receive side apparatus 200. Although the communication interface circuit 500 is provided in the transmit side apparatus 100, needless to say, it may be provided in the receive side apparatus 200. Used as the communication interface circuit 500 can be a serial interface circuit (RS232C, USB, IEEE1394, and the like) for converting transfer-data of, for example, one byte into serial data and transferring, and a parallel interface circuit (Centronics Interface, SCSI, IDE, and the like) for transferring plural bits of transfer-data at the same time. Note that in the description below, the communication interface circuit 500 is a serial interface circuit.

The receive side apparatus 200 is an integrated circuit such as a microcomputer, and performs various processing according to the content of transfer-data transferred from the transmit side apparatus 100. Here, if the communication system according to the present invention is, for example, a voice processing system, the receive side apparatus 200 is, for example, an MP3 decoder. Needless to say, the communication system according to the present invention is not limited to the voice processing system, but can be adopted as systems of various fields such as an image processing system and a digital broadcast transmit/receive system.

Furthermore, the receive side apparatus 200 has a receive data buffer 210 temporarily storing transfer-data DAT transferred from the communication interface circuit 500 of the transmit side apparatus 100. The receive side apparatus 200 has a control section (not shown) that when the amount of transfer-data DAT stored in the receive data buffer 210 reaches a predetermined amount, transmits a WAIT signal (notice signal) to notify to that effect.

The level of the WAIT signal is set to “1”, for example, when the amount of transfer-data DAT stored in the receive data buffer 210 reaches the predetermined amount. When the receive data buffer 210 is again put in an empty state (when having resolved the state of having reached the predetermined amount) by moving transfer-data DAT stored in the receive data buffer 210 to RAM (not shown) or the like, the level of the WAIT signal is set to “0”.

### CONFIGURATION OF THE COMMUNICATION INTERFACE CIRCUIT

The configuration of the communication interface circuit 500 of the transmit side apparatus 100 will be explained. The communication interface circuit 500 comprises a RAM 510, a shift register 520, an empty detection circuit 530, a control circuit (control section) 540, a clock generation circuit 550, a data transfer amount setting register 560, a counter (section that detects the amount of transfer-data) 570, and a comparator 580.

RAM 510 functions as a so-called transmit buffer that temporarily stores transfer-data DAT received via internal data bus 400 from CPU 300.

Shift register 520 temporarily stores data of a predetermined size (one or a plurality of bytes), which is to be transferred in one transfer sequence, out of transfer-data DAT stored in RAM 510. Hereinafter, it is called “data load” to store transfer-data DAT of a predetermined size into shift register 520.

Furthermore, shift register 520 shifts transfer-data DAT of the predetermined size stored, bit by bit in response to clock signal CLK supplied by the clock generation circuit 550. By this shift operation, the transfer of transfer-data DAT to the receive side apparatus 200 is performed.

Empty detection circuit 530 is a circuit that detects whether transfer-data DAT is stored in shift register 520. Empty detection circuit 530 can be implemented by, for example, a logic circuit that has an empty flag 531 and detects whether the bits of the counter 570 are all at 0 or 1.

When data load from RAM 510 into shift register 520 finishes, empty flag 531 is set to “0” indicating that transfer-data DAT is stored in shift register 520. After all transfer-data DAT stored in shift register 520 is then transferred to the receive side apparatus 200, empty flag 531 is set to “1” indicating that no transfer-data DAT is stored in shift register 520.

Control circuit 540 comprises, as control registers, a RUN flag 541, a STOP flag 542, and an END flag 543. When RUN flag 541 is at “1” and empty flag 531 is at “0”, control circuit 540 transmits to the clock generation circuit 550 a clock generation enabling signal that enables the generation of clock signal CLK. As a result, the clock generation circuit 550 controls whether to generate clock signal CLK, according to the clock generation enabling signal. Furthermore, when STOP flag 542 is at “1”, control circuit 540 controls to prohibit data load from RAM 510 into shift register 520.

RUN flag 541 is held at “1” from the time when the transfer of transfer-data DAT from shift register 520 starts until the transfer of all transfer-data stored beforehand in RAM 510 finishes, and otherwise, held at “0”.

STOP flag 542 is set to “1” when the WAIT signal of “1” in level is received from the receive side apparatus 200, and after that, when the WAIT signal changes in level from “1” to “0”, set to “0”.

END flag 543 is set to “1” when the transfer of all transfer-data stored beforehand in RAM 510 finishes. After that, END flag 543 is reset to “0”.

Clock generation circuit 550 generates clock signal CLK to transfer transfer-data DAT synchronous with, according to the clock generation enabling signal supplied from control circuit 540. Note that clock signal CLK is supplied to shift register 520 to be used in its shift operation and to counter 570 to be used in its count operation.

Data transfer amount setting register 560 is a register to set the amount of data to be transferred to the receive side apparatus 200. That is, data transfer amount setting register 560 is set to the same value as the amount of transfer-data DAT stored in RAM 510.

Counter 570 is a circuit that counts clocks of clock signal CLK supplied from clock generation circuit 550 to measure the amount of transfer-data DAT (hereinafter, called already-transferred data amount) transferred from shift register 520 to the receive side apparatus 200. That is, one clock of clock signal CLK is generated synchronously with the transfer of one bit of transfer-data DAT from shift register 520 thereby enabling the above count operation. Comparator 580 compares the data transfer amount set in the data transfer amount setting register 560 with the already-transferred data amount counted in counter 570, and when both are equal, transmits an equal signal to that effect to the control circuit 540. Control circuit 540 can detect from this equal signal that the transfer of all transfer data stored beforehand in RAM 510 from shift register 520 is complete.

### OPERATION OF THE COMMUNICATION INTERFACE CIRCUIT

<Normal Operation>

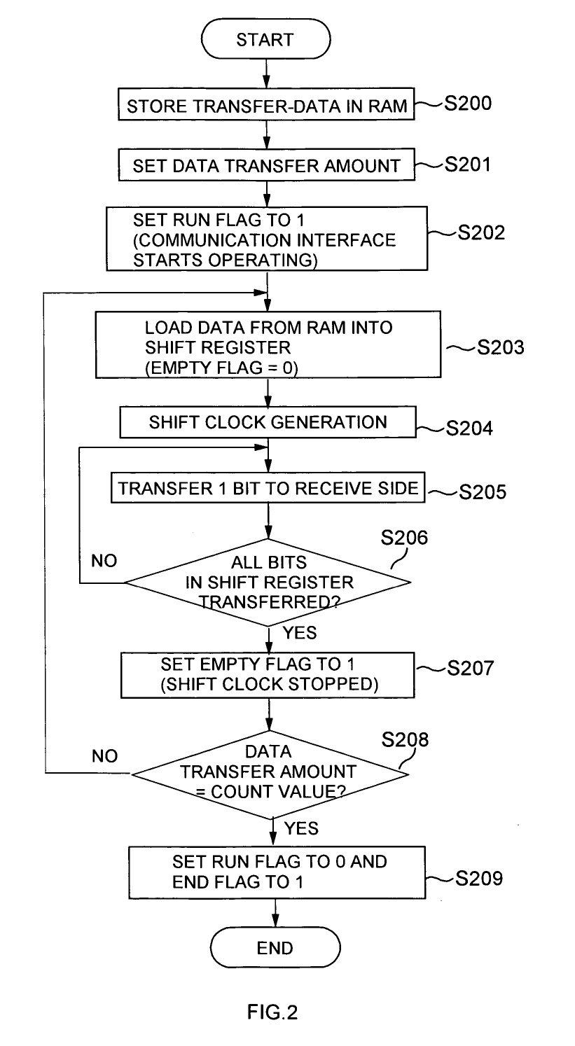

The normal operation of the communication interface circuit 500 will be explained based on the flow chart of FIG. 2.

First, transfer-data DAT is temporarily stored in RAM 510 via internal data bus 400 from CPU 300 (S200), and at the same time, the data transfer amount is set in the data transfer amount setting register 560 (S201). At this point in time, control circuit 540 sets RUN flag 541 to “1” so as to start control to load transfer-data DAT from RAM 510 into shift register 520 by the predetermined size (e.g. byte by byte) (S202).

When the load of data of the predetermined size from RAM 510 into shift register 520 finishes, transfer-data DAT of the predetermined size is stored in shift register 520, and hence the empty detection circuit 530 sets empty flag 531 to “0” (S203). At this point in time, because RUN flag 541 is at “1” and empty flag 531 is “0”, control circuit 540 controls clock generation circuit 550 to generate clocks of clock signal CLK corresponding in number to the predetermined size of transfer-data DAT stored in shift register 520 (S204).

Shift register 520 transfers one bit of transfer-data DAT to the receive side apparatus 200 by shifting in response to a clock of clock signal CLK supplied from clock generation circuit 550 (S205). This shift is repeated until all transfer-data DAT in shift register 520 has been transferred to the receive side apparatus 200 (S206: NO). Note that, at this time, counter 570 counts the amount of already-transferred data transferred from shift register 520.

Then, when all transfer-data DAT in shift register 520 has been transferred to the receive side apparatus 200 (S206: YES), the empty detection circuit 530 sets empty flag 531 to “1” (S207). At this time, the condition that RUN flag 541 is at “1” and empty flag 531 is at “0” does not hold true, control circuit 540 controls the clock generation circuit 550 to stop generating clock signal CLK (S207).

Here, if RAM 510 stores transfer-data DAT of the predetermined size to be transferred next, until the data transfer amount set in the data transfer amount setting register 560 and the count received from counter 570 coincide in comparator 580, the processes of S203 through S207 are repeated (S208: NO).

Then, when the data transfer amount set in the data transfer amount setting register 560 and the count received from counter 570 coincide (S208: YES), control circuit 540 sets RUN flag 541 to “0” and END flag 543 to “1”.

<Suspension and Resumption>

Communication interface circuit 500, with the receipt of the WAIT signal from receive side apparatus 200 set as an interrupt factor, in response to the occurrence of that interrupt, suspends and resumes the sequential transfer of transfer-data DAT. That is, communication interface circuit 500 deals with suspension and resumption of the sequential transfer as processing asynchronous with normal processing shown in FIG. 2.

<<Suspension>>

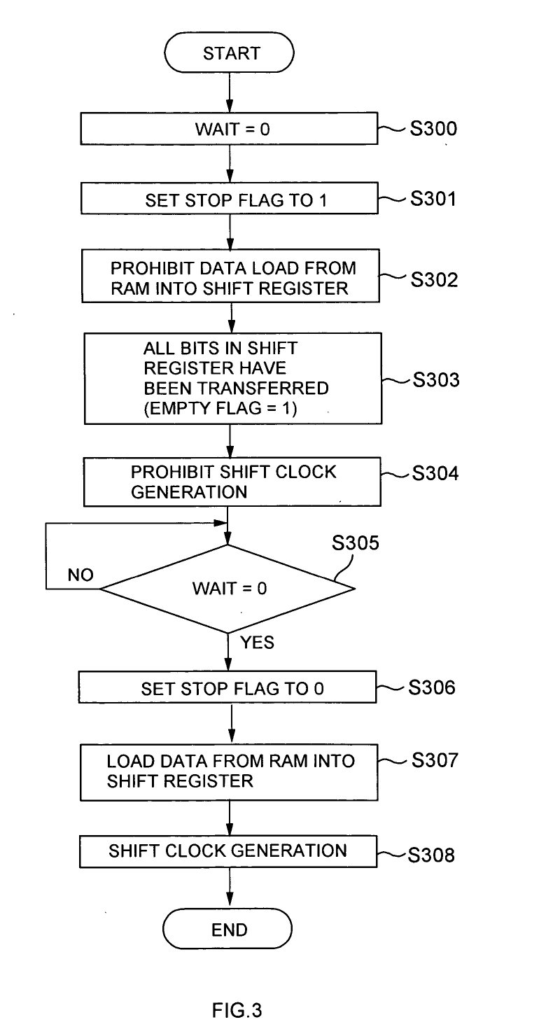

The operation where communication interface circuit 500 suspends the sequential transfer of transfer-data DAT will be explained based on the flow chart of FIG. 3.

First, when the amount of transfer-data DAT stored in receive data buffer 210 reaches a predetermined amount, the receive side apparatus 200 transmits the WAIT signal of “1” in level to the transmit side apparatus 100. Communication interface circuit 500 receives the WAIT signal transmitted from receive side apparatus 200 via internal data bus 400 (S300). Transmit side apparatus 100 has received the WAIT signal of “1” in level, and thereby control circuit 540 sets STOP flag 542 to “1” (S301).

In response to STOP flag 542 being set to “1”, control circuit 540 sets so as to prohibit the next data load from RAM 510 into shift register 520 (S302). After that, the transfer of all bits of transfer-data DAT stored in shift register 520 finishes, and thereby empty flag 531 is set to “1” (S303). Empty flag 531 is held at “1” until the next data load is performed.

In response to empty flag 531 being set to “1”, control circuit 540 prohibits the generation of clock signal CLK in the clock generation circuit 550 via the clock generation enabling signal (S304).

<<Resumption>>

The operation where communication interface circuit 500 resumes the sequential transfer of transfer-data DAT will be explained based on the flow chart of FIG. 3.

Communication interface circuit 500 maintains the current operational state until the WAIT signal received from receive side apparatus 200 changes from “1” to “0” (S305: NO) . That is, data load from RAM 510 into shift register 520 is prohibited and clock signal CLK is stopped.

When the WAIT signal received from receive side apparatus 200 is at “0” (S305: YES), communication interface circuit 500 sets STOP flag 542 to “0” via control circuit 540 (S306). As a result, the prohibition of data load from RAM 510 into shift register 520 is released.

After that, control circuit 540 loads transfer-data DAT of the predetermined size to be transferred next from RAM 510 into shift register 520 (S307). As a result, empty flag 531 is set to “0”, the prohibition of clock signal CLK generation in the clock generation circuit 550 is released (S308).

### SPECIFIC EXAMPLE OF DATA TRANSFER

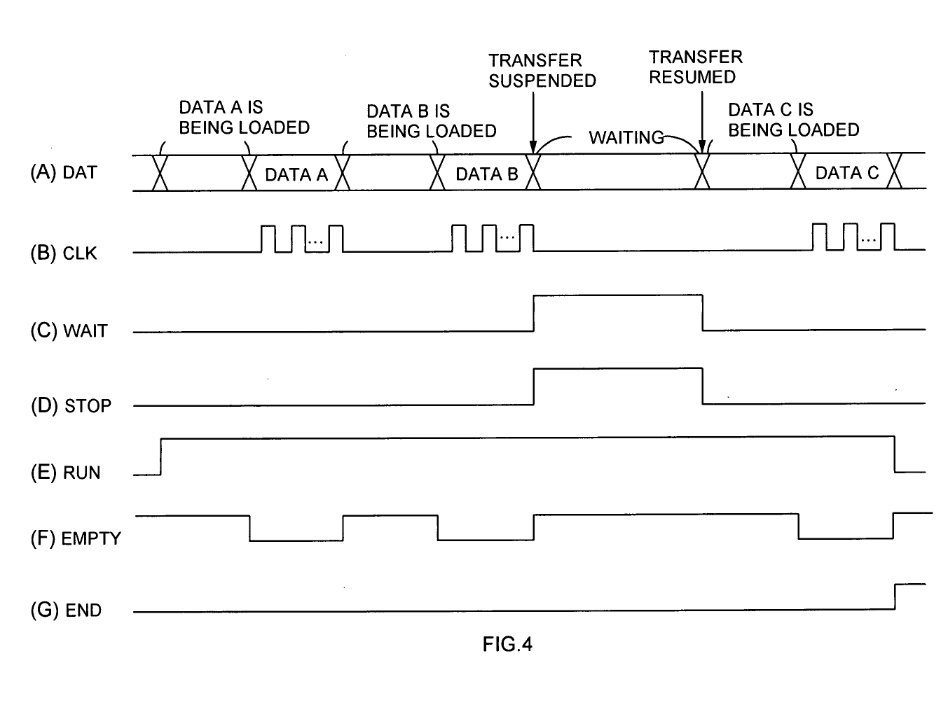

Specific operation performed in communication interface circuit 500 will be explained based on the timing chart shown in FIG. 4.

In the description below, it is assumed that communication interface circuit 500 sequentially transfers data A, data B, and data C stored beforehand in RAM 510 and that, before transferring data C, the amount of transfer-data DAT stored in receive data buffer 210 reaches a predetermined amount, and thus receive side apparatus 200 transmits the WAIT signal of “1” in level to the transmit side apparatus 100.

First, transfer-data DAT is not stored in shift register 520 and hence, empty flag 531 is held at “1” (see (F) of FIG. 4). Then, RUN flag 541 is set to “1” (see (E) of FIG. 4), at which time data A starts to be loaded from RAM 510 into shift register 520.

After the loading of data A finishes, empty flag 531 is set to “0”. Further, after data A and clock signal CLK are transferred to the receive side apparatus 200 (see (A) and (B) of FIG. 4) until data B to be transferred next is loaded from RAM 510 into shift register 520, empty flag 531 is held at “1” (see (F) of FIG. 4). Then, data B and clock signal CLK are transferred to the receive side apparatus 200 (see (A) and (B) of FIG. 4). After the transfer of data B finishes, empty flag 531 is held at “1” (see (F) of FIG. 4).

Meanwhile, in receive side apparatus 200, data A and data B received from communication interface circuit 500 are stored in receive data buffer 210, and thereby the amount of transfer-data DAT stored in receive data buffer 210 reaches the predetermined amount. As a result, receive side apparatus 200 transmits the WAIT signal of “1” in level to the transmit side apparatus 100 (see (C) of FIG. 4).

Because the level of the WAIT signal received from receive side apparatus 200 is at “1”, communication interface circuit 500 sets STOP flag 542 to “1” via control circuit 540 (see (D) of FIG. 4). As a result, data load from RAM 510 into shift register 520 is prohibited, and hence empty flag 531 is held at “1”, after the transfer of data B finishes (see (F) of FIG. 4). Further, the generation of clock signal CLK is prohibited and thereby clock signal CLK stays in the stop state (see (B) of FIG. 4).

After that, when data stored in receive data buffer 210 is then moved to RAM (not shown) or the like and thereby the receive side apparatus 200 becomes ready to receive, the receive data buffer 210 gets in an empty state and the receive side apparatus 200 transmits the WAIT signal of “0” in level to the transmit side apparatus 100 (see (C) of FIG. 4). As a result, the level of the WAIT signal changes from “1” to “0”, and hence communication interface circuit 500 sets STOP flag 542 to “0” via control circuit 540 (see (D) of FIG. 4).

In response to STOP flag 542 changing from “1” to “0”, communication interface circuit 500 releases the prohibition of data load from RAM 510 into shift register 520 and the prohibition of clock signal CLK generation, thereby resuming the transfer of data C subsequent to data B.

Then, data C is loaded from RAM 510 into shift register 520 and empty flag 531 is set to “0” (see (F) of FIG. 4). After the loading of data C finishes, data C and clock signal CLK are transferred to the receive side apparatus 200 (see (A) and (B) of FIG. 4). In response to the completion of the transfer of all of data A, data B, and data C, RUN flag 541 is set to “0” (see (E) of FIG. 4), END flag 543 to “1” (see (G) of FIG. 4), and empty flag 531 to “1” (see (F) of FIG. 4).

### EFFECTS

Communication interface circuit 500 can suspend sequential transfer from the transmit side apparatus 100 to the receive side apparatus 200 as needed, and when the transfer suspension is released, the sequential transfer can be resumed from data DAT subsequent to data last transferred before suspension. Thus, duplicate transfer data is not transferred from the transmit side apparatus 100, and hence malfunction can be avoided in the receive side apparatus 200. Furthermore, the traffic amount between the transmit side apparatus 100 and the receive side apparatus 200 can be reduced by that of duplicate transfer data that would otherwise be transferred, and efficient transfer is possible.

When receiving the WAIT signal from the receive side apparatus 200, communication interface circuit 500 suspends the sequential transfer of data DAT. Hence, the receive side apparatus 200 can avoid such malfunction as deleting transfer-data DAT stored in the receive data buffer 210 by overwriting. Moreover, according to communication interface circuit 500 of the present invention, when detecting on the basis of the WAIT signal that the state is resolved where the amount of transfer-data DAT stored in receive data buffer 210 reached the predetermined amount, the sequential transfer can be resumed from data subsequent to data last transferred before suspension. Thus, duplicate transfer-data DAT is not written into receive data buffer 210, and hence malfunction can be avoided. Furthermore, receive data buffers 210 need not be switched according to the amount of transfer-data DAT to be transferred from the transmit side apparatus 100.

When suspending the sequential transfer of data DAT, communication interface circuit 500 prohibits the generation of clock signal CLK in clock generation circuit 550. Hence, the situation where receive side apparatus 200 receives superfluous clocks of clock signal CLK can be avoided, and thus malfunction can be avoided.

In response to the completion of data load into shift register 520, communication interface circuit 500 controls to start the generation of clock signal CLK, and in response to the completion of the transfer of data DAT from shift register 520, controls to prohibit the generation of clock signal CLK. Hence, receive side apparatus 200 receives the requisite number of clocks of clock signal CLK according to the size of transfer-data DAT from transmit side apparatus 100. That is, it is prevented that receive side apparatus 200 receives superfluous clocks of clock signal, and thus malfunction can be avoided.

While the sequential transfer of data DAT to the receive side apparatus 200 is suspended according to the WAIT signal, communication interface circuit 500 certainly prohibits data load from RAM 510 into shift register 520. As a result, when an erroneous shift operation occurs in shift register 520, new transfer-data DAT is not loaded from RAM 510 into shift register 520 during the suspension of the sequential transfer to the receive side apparatus 200. Thus, it is avoided that receive side apparatus 200 receives superfluous transfer-data DAT.

As described above, according to the communication interface circuit 500, control method therefor and transmit side apparatus (microcomputer) 100 of the present invention, malfunction of the receive side apparatus 200 in the sequential transfer of transfer-data DAT can be avoided thus improving reliability of the sequential transfer of transfer-data DAT between the transmit side apparatus 100 and the receive side apparatus 200.

### OTHER EMBODIMENTS

Although the embodiment according to the present invention has been described, the above embodiment is provided to facilitate the understanding of the present invention and not intended to limit the present invention. It should be understood that various changes and alterations can be made therein without departing from the spirit and scope of the present invention and that the present invention includes equivalents thereof.

For example, communication interface circuit 500 may notify the amount of already-transferred data counted by counter 570 to the receive side apparatus 200 via data bus 400, CPU 300 and the like. By this means, the receive side apparatus 200 can confirm whether superfluous transfer-data DAT has been received by, for example, comparing the already-transferred data amount notified with the amount of transfer-data DAT actually received.

Moreover, communication interface circuit 500 may be a parallel interface circuit as above, in which case a serial/parallel converter converting the serial data output of shift register 520 into a parallel data may be additionally provided in communication interface circuit 500 of FIG. 1 or shift registers 520 corresponding in number to the size of parallel data transferred at the same time may be provided.

Furthermore, communication interface circuit 500 may have an interface function for receiving. In this case, communication interface circuit 500 is configured to have a bidirectional buffer at the port for transferring transfer-data DAT.

1. A communication interface circuit which performs control to sequentially transfer transfer-data each having a predetermined size from a first apparatus to a second apparatus, the communication interface circuit comprising:
a control section that, while sequentially transferring the transfer-data each having the predetermined size to the second apparatus, can suspend the sequential transfer, and where the suspension is effected and then released, resumes the sequential transfer from data subsequent to last transferred data before the suspension out of the transfer-data.

2. The communication interface circuit according to claim 1, wherein the second apparatus comprises:
a buffer section that temporarily stores the transfer-data transferred from the first apparatus, and
a section that, when the amount of the transfer-data stored has reached a predetermined amount, transmits a notice signal to notify of having reached the predetermined amount,
and wherein, when receiving the notice signal from the second apparatus, the control section controls to effect the suspension, and after the suspension, when the notice signal ceases to notify, controls to effect the resumption.

3. The communication interface circuit according to claim 2, further comprising:
a clock generation circuit that generates a clock signal for transferring the transfer-data and transmits the clock signal to the second apparatus,
wherein, when receiving the notice signal from the second apparatus, the control section controls to prohibit generation of the clock signal in the clock generation circuit, and after the suspension, when the notice signal ceases to notify, controls to release the prohibition.

4. The communication interface circuit according to claim 3, further comprising:
a shift register that stores transfer-data of the predetermined size and transfers the transfer-data stored to the second apparatus,
wherein, when transfer-data of the predetermined size is stored into the shift register, the control section controls to start generation of the clock signal in the clock generation circuit, and when transfer of the transfer-data of the predetermined size from the shift register finishes, controls to prohibit generation of the clock signal in the clock generation circuit.

5. The communication interface circuit according to claim 2, further comprising:
a shift register that stores transfer-data of the predetermined size and transfers the transfer-data stored to the second apparatus,
wherein, when receiving the notice signal from the second apparatus, the control section controls to prohibit storing transfer-data of the predetermined size into the shift register.

6. The communication interface circuit according to claim 4, wherein the control section comprises:
a section that detects the amount of the transfer-data transferred from the shift register, and
a section that notifies the amount of the transfer-data to the second apparatus.

7. The communication interface circuit according to claim 1, which is a serial interface circuit.

8. The communication interface circuit according to claim 1, which is a parallel interface circuit.

9. The communication interface circuit according to claim 1, which is provided in the first apparatus.

10. The communication interface circuit according to claim 1, which is provided in the second apparatus.

11. The communication interface circuit according to claim 1, which is a microcomputer.
